(19) United States
(12) Patent Application Publication
(10) Pub. No.: US 2011/0094622 A1
(43) Pub. Date: Apr. 28, 2011

(54) Funnel Keeper

(76) Inventor: Robert J. McLoy, Tucson, AZ (US)

(21) Appl. No.: 12/914,897

(22) Filed: Oct. 28, 2010

Related U.S. Application Data
(60) Provisional application No. 61/255,774, filed on Oct. 28, 2009.

(51) Int. Cl. B67C 11/00; B23P 19/00

(52) U.S. Cl. 141/340; 29/428

(57) ABSTRACT

An assembly for storing a funnel and draining a residue therefrom is presented. The device comprises a tubular base portion that can be affixed to a vertical surface and a tubular holding member coupled to the base portion, where the holding member can hold a funnel. The assembly further comprises a catch releasably affixed thereto such that a residue in the funnel can flow through the holding member and into the catch.

### CROSS-REFERENCE TO RELATED APPLICATIONS

This application claims priority to a U.S. Provisional Application having Ser. No. 61/255,774 which was filed on Oct. 28, 2009.

### FIELD OF THE INVENTION

This invention discloses a devices for storing funnels and more particularly a device for storing funnels wherein residue from the funnels can drain into a catch for subsequent disposal.

### BACKGROUND

Funnels are highly useful tools for channeling liquid or fine-grain substances into containers with small openings. In many situations, without the use of a funnel, spillage would occur. However, users are often left in a dilemma of what to do with the funnels between uses. Funnels that are left on a flat surface can roll and any remaining residue in the funnel can leak out and make a mess. Alternatively, used funnels can be left in the container they were used with, but this leaves the container open and exposed to contaminants as well as creates the potential for spills should the container be knocked over. Further, there is the issue of how to properly clean a funnel when it has been used with harmful substances which then coat the inside of the funnel. Rinsing the funnel off disposes the residue into the water system which, depending on the residue, may not be a proper disposal method. Rags or towels may be used to wipe out the funnel, but then the soiled rags or towels must be disposed off. Thus, there is a need for a manner of neatly storing used funnels which allows any remaining residue to be properly disposed of.

### SUMMARY

An assembly for storing a funnel and draining a residue therefrom is presented. The assembly comprises a tubular base portion and a tubular holding member coupled to the base portion, where the holding member comprises an upwardly-facing aperture to accommodate a funnel. The holder further comprises a catch releasably affixed to the holding member such that a residue in the funnel can flow through the holding member and into the catch.

An assembly for storing a plurality of funnels, and draining residue therefrom is presented. A method to store one or more funnels, and to drain and collect a residue therefrom is presented.

### BRIEF DESCRIPTION OF THE DRAWINGS

The invention will be better understood from a reading of the following detailed description taken in conjunction with the drawings in which like reference designators are used to designate like elements, and in which:

FIG. 1 is an exemplary embodiment of Applicant's invention holding a single funnel;

FIG. 2 is an exemplary embodiment of Applicant's invention wherein a funnel holder is mounted at an angle with respect to a wall;

FIG. 3 is an exemplary embodiment of Applicant's invention capable of holding multiple funnels; and

FIG. 4 is an exemplary embodiment of Applicant's invention capable of holding multiple funnels.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Applicant's invention comprises a device to store funnels after they have been used. Moreover, Applicant's invention allows any residue remaining inside the funnels to drain into a reservoir, wherein the reservoir can later be cleaned or disposed of.

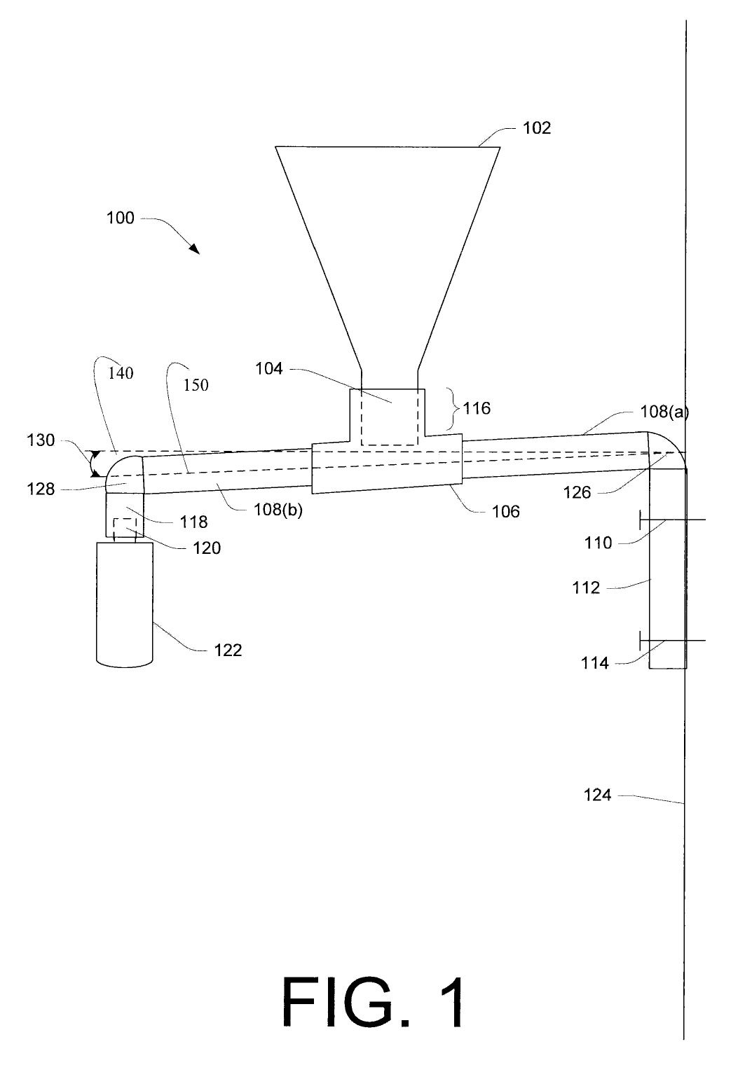

Referring now to FIG. 1, an embodiment of Applicant's invention is presented wherein a single funnel 102 can stored. Funnel 102 comprises a truncated conical portion and a stem portion extending outwardly from a narrow end of the truncated cone, wherein the stem portion comprises a stem diameter, and wherein the funnel was used to channel a fluid comprising a viscosity.

Assembly 100 comprises base portions 108(a) and 108(b), connecting member 106, shoulders 128 and 126, attachment arm 112, and catch 122, wherein base portions 108(a) and 108(b), connecting member 106, and shoulder 128, are tubular to allow fluids to flow through. In certain embodiments, shoulder 126 and attachment arm 112 are non-tubular.

Attachment arm 112 is coupled to base portion 108(a) via elbow 126 and connecting member 118 is attached to base portion 108(b) via elbow 128. In certain embodiments, the attachment comprises a tapered portion of one element being disposed in a larger diameter portion of the other element such that friction between the elements maintains the attachment. In other embodiments, the elements each comprise threaded portions such an external threaded element can be releaseably attached to an internally threaded element. In other embodiments, the attachment may be achieved by a combination of threaded elements and friction coupling. In certain embodiments, base portions 108(a) and 108(b), connecting members 106 and 118, attachment arm 112, and elbows 126 and 128, comprise an integral assembly. In certain embodiments, such an integral assembly is formed by injection molding.

In certain embodiments, connecting member 118 is releaseably attached to catch 122 via neck 120. Catch 122 comprises a reservoir for residue from funnel 102. In certain embodiments, catch 122 is reusable and can be removed from connecting member 118 and cleaned. In other embodiments, catch 122 is disposable. In such embodiments, catch 122 may be sealed when removed from connecting member 118. As will be appreciated by one of ordinary skill in the art, when funnel 102 was used with a toxic or otherwise dangerous substance, having a sealable container for the residue to drain into facilitates proper disposal in a safe and environmentally sensitive manner. In certain embodiments, catch 122 is self-sealing. In other embodiments, catch 122 must be manually sealed using a cap or a lid. In certain embodiments, catch 122 further comprises a filter. By employing such a filter, catch 122 can remove harmful particulates from a fluid residue, allowing the filtered residue to be disposed of separately from the harmful particulates, thereby further facilitating proper and environmentally sensitive disposal.

In certain embodiments, catch 122 comprises plastic. In certain embodiments, catch 122 comprises a metal. In certain embodiments, catch 122 comprises glass. In certain embodiments, catch 122 is a composite. In certain embodiments, catch 122 is recyclable.

In the illustrated embodiment of FIG. 1, catch 122 comprises a cylinder. In other embodiments, catch 122 can have a variety of shapes and dimensions. Furthermore, while the embodiment of FIG. 1 is depicted having one catch, in other embodiments system 100 comprises multiple catches.

In the illustrated embodiment of FIG. 1, connecting member 106 comprises upwardly facing tubular portion 116, wherein stem portion 104 of funnel 102 can be removeably disposed in tubular portion 116 such that funnel 102 is maintained in a substantially upright orientation. The dimensions of tubular portion 116 can be adjusted to accommodate different stem lengths and diameters.

In the illustrated embodiment of FIG. 1, attachment arm 112 attaches to a wall or other vertical surface, such as surface 124, via fasteners 110 and 114. fasteners 110 and 114 may, by way of example and not limitation, be screws, bolts, nails, clamps, or any other means of securing attachment arm 112 to surface 124, or combination thereof.

In certain embodiments, assembly 100 is pivotally attached to surface 124 by fasteners 110 and 114. In these embodiments, assembly can be rotated about ninety degrees from the orientation of FIG. 1 such that elements 106, 108(a), and 108(b), are disposed adjacent surface 124 when funnel 102 is removed from assembly 100.

In certain embodiments, assembly 100 does not comprise attachment arm 112. In such embodiments, base portion 108(a) connects directly to surface 124.

In the illustrated embodiment of FIG. 1, elements 106, 108(a), and 108(b), in combination, comprise an axial centerline 150. Axial centerline 150 and a horizontal line 140 define a dihedral angle 130. As those skilled in the art will appreciate, the greater dihedral angle 130, the greater the downward slope of elements 106, 108(a), and 108(b). When attachment arm 112 is attached to surface 124, assuming surface 124 is a vertical surface, then elements 106, 108(a), and 108(b) are disposed at an angle of 90 degrees less angle 130 to surface 124. As a result, gravity will cause any residual fluids to drain from funnel 102 through base portion 108(b) and into catch 122.

In certain embodiments, angle 130 can be adjusted. In certain embodiments, angle 130 increases in proportion to the log of the viscosity of subject fluids, where the viscosity is measured in centipoises (cP). For example, if fluids having a viscosity of between 1 and 10 are used with funnel 102, then angle 130 can be adjusted to be between about 0 to about 10 degrees. Such fluids would include mineral spirits, water, and other organic solvents.

If fluids having a viscosity of between 10 and 100 are used with funnel 102, then angle 130 can be adjusted to be between about 10 to 20 degrees. Such fluids would include 10 weight motor oil and various paints. If fluids having a viscosity of between 100 and 1000 are used with funnel 102, then angle 130 can be adjusted to be between about 20 to about 30 degrees. Such fluids would include 20-50 weight motor oil. If fluids having a viscosity of between 1000 and 10,000 are used with funnel 102, then angle 130 can be adjusted to be between about 30 to about 40 degrees. Such fluids would include honey, corn syrup, molasses, and the like.

In certain embodiments, base portions 108(a) and 108(b), connecting members 106 and 118, attachment arm 112, and elbows 126 and 128 are separable. In such embodiments, base portions 108(a) and 108(b), connecting members 106 and 118, attachment arm 112, and elbows 126 and 128 are washable and reusable. In other embodiments, base portions 108(a) and 108(b), connecting members 106 and 118, attachment arm 112, and elbows 126 and 128 are disposable. In such embodiments, only those components having residue flowing through them may be disposable.

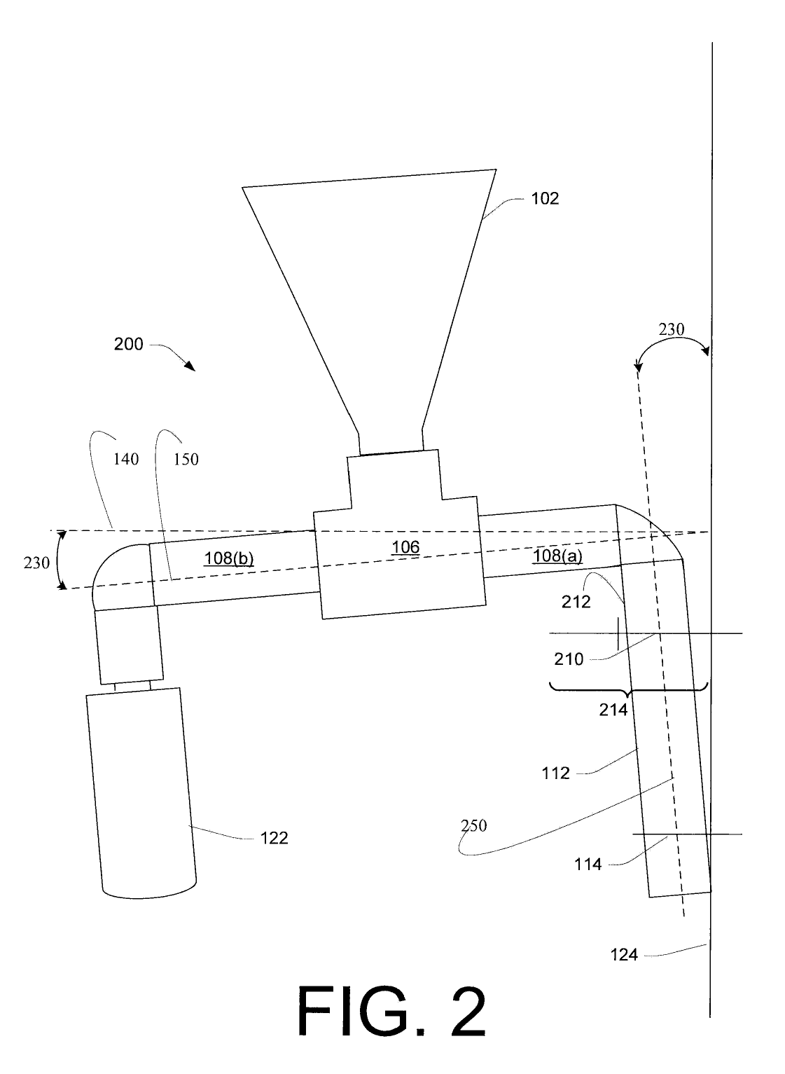

Turning now to FIG. 2, an assembly 200 embodiment of Applicant's invention is presented. In the illustrated embodiment of FIG. 2, attachment arm comprises a centerline 250. Attachment arm centerline 250 and vertical surface 124 define dihedral angle 230. In certain embodiments, angle 230 can be adjusted based upon the viscosity of the fluids utilized with funnel 102, in accord with the description hereinabove. In certain embodiments, fastener 210 defines dihedral angle 230. In certain embodiments, the distance between member 212 and surface 124 can be adjusted along length 214. As the distance between member 212 and vertical surface 124 decreases, then dihedral angle 230 also decreases. Conversely, as the distance between member 212 and vertical surface 124 increases, then dihedral angle 230 also increases.

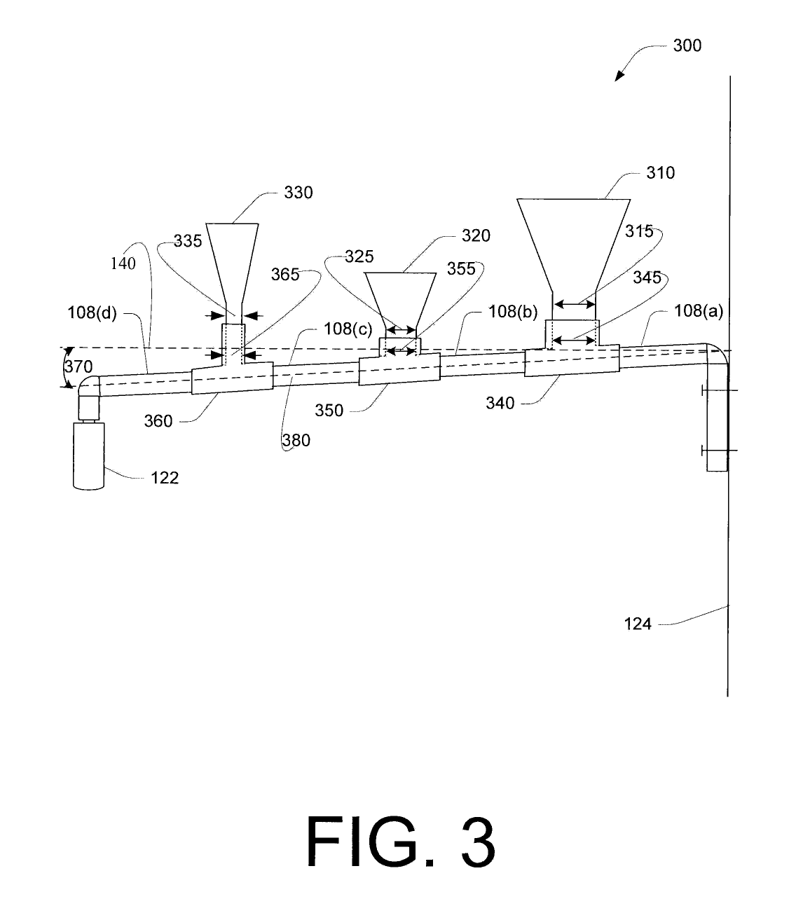

Turning now to FIG. 3, a third embodiment of Applicant's invention is presented wherein assembly 300 can hold multiple funnels. As can be seen in the illustrated embodiment of FIG. 3, a sub-assembly comprising base portions 108(a), 108(b), 108(c) and 108(d), in combination with connecting members 340, 350, and 360, accommodates multiple funnels, in this case funnels 310, 320, and 330.

The sub-assembly comprising elements 108(a), 108(b), 108(c), 108(d), 340, 350, and 360, comprises an axial centerline 380. The orientation of this sub-assembly is defined by the dihedral angle 370 formed by axial centerline 380 and a horizontal line 140. This horizontal orientation can be adjusted either by adjusting the orientation of base portion 108(a) with respect to shoulder 126, or by adjusting the distance of member 212 from surface 124.

As will be appreciated by one of ordinary skill in the art, the embodiment depicted in FIG. 3 is meant to be illustrative and not limiting. In other embodiments, any number of funnels may be held by assembly 100 by using additional base portions and connecting members.

In the illustrated embodiment of FIG. 3 funnel 310 comprises a stem having a diameter 315, and funnel 320 comprises a stem having a diameter 325, and funnel 330 comprises a stem having a diameter 335. Further in the illustrated embodiment of FIG. 3, connecting member 340 comprises an upwardly-facing aperture having a diameter 345, wherein diameter 345 is substantially equal to diameter 315. By “substantially equal to,” Applicant means plus or minus ten percent (10%).

Connecting member 350 comprises an upwardly-facing aperture having a diameter 355, wherein diameter 355 is substantially equal to diameter 325. Connecting member 360 comprises an upwardly-facing aperture having a diameter 365, wherein diameter 365 is substantially equal to diameter 335. Thus, assembly 300 can be adjusted to store any number of funnels wherein each funnel comprises differing dimensions.

Furthermore, while the embodiment depicted in FIG. 3 is shown having only a single catch, a person of ordinary skill in the art will appreciate that multiple catches may be employed without departing from the present invention. In such an embodiment, each catch may be placed anywhere along assembly 300, such as, and without limitation, under each connecting member 106(a)-(c), to one side of assembly 300, or connected to one another.

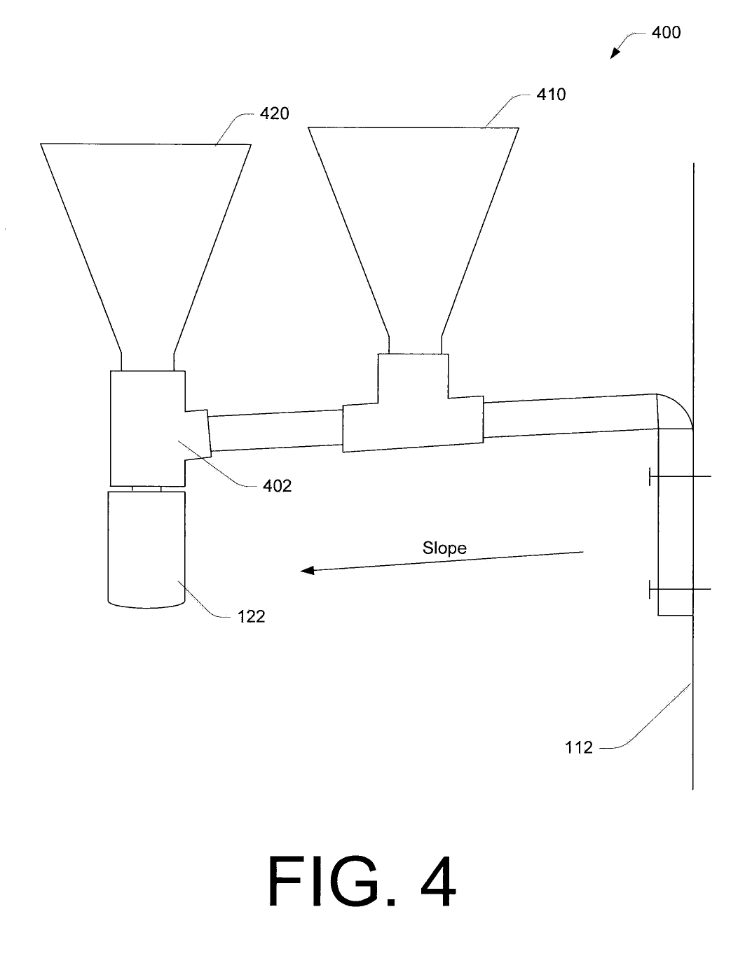

Turning now to FIG. 4, an embodiment 400 of Applicant's invention is presented, wherein assembly 400 is illustrated storing funnel 410 and funnel 420. In the illustrated embodiment of FIG. 4, elbow 128 (FIG. 1), has been replaced by connector 402, wherein connector 402 is capable of holding a funnel, such as funnel 102(b).

While the preferred embodiments of the present invention have been illustrated in detail, it should be apparent that modifications and adaptations to those embodiments may occur to one skilled in the art without departing from the scope of the present invention as set forth in the following claims.

I claim:

1. An assembly for storing a funnel, comprising:
a tubular base portion that can be affixed to a vertical surface;
a tubular holding member in fluid communication with the base portion, wherein the holding member is formed to include an upwardly-facing aperture, and wherein a subassembly comprising said base portion and said holding member comprise an axial centerline;
a tubular elbow in fluid communication with a first end of said subassembly; and
a catch in fluid communication with, and releaseably affixed to, the tubular elbow.

2. The assembly of claim 1, wherein the catch is sealable when not affixed.

3. The assembly of claim 1, wherein the catch is disposable.

4. The assembly of claim 1, wherein the catch further comprises a filter.

5. The assembly of claim 1, further comprising:
a non-tubular elbow attached to a second end of said subassembly; and
a non-tubular attachment arm attached to a distal end of said non-tubular elbow and extending outwardly therefrom.

6. The assembly of claim 5, further comprising a U-bracket attachment device for pivotally attaching said attachment arm to a vertical surface.

7. The assembly of claim 6, wherein:
said attachment arm comprises an axial centerline; and
an angle between said axial centerline and said vertical surface can be adjusted from about zero degrees to about 40 degrees.

8. An assembly for storing a plurality of funnels, comprising:
a tubular base portion;
two or more tubular holding members in fluid communication with the base portion, wherein each tubular holding member is formed to include an upwardly-facing aperture, and wherein a subassembly comprising said base portion and two or more holding members comprises an axial centerline;
a tubular elbow in fluid communication with a first end of said subassembly; and
a catch in fluid communication with, and releaseably affixed to, the tubular elbow.

9. The device of claim 8, wherein:
at least one holding member can hold a first funnel having a stem comprising a first diameter; and
at least one holding member can hold a first funnel having a stem comprising a second diameter, wherein the first diameter and the second diameter differ.

10. The assembly of claim 9, further comprising:
a non-tubular elbow attached to a second end of said subassembly; and
a non-tubular attachment arm attached to a distal end of said non-tubular elbow and extending outwardly therefrom.

11. The assembly of claim 10, further comprising a U-bracket attachment device for pivotally attaching said attachment arm to a vertical surface.

12. The assembly of claim 11, wherein:
said attachment arm comprises an axial centerline; and
an angle between said axial centerline and said vertical surface can be adjusted from about zero degrees to about 40 degrees.

13. A method to store and drain a funnel, comprising:
providing a funnel storing assembly comprising a tubular base portion, a tubular holding member in fluid communication with the base portion, a tubular elbow in fluid communication with a first end of said subassembly, a catch in fluid communication with, and releaseably affixed to, the tubular elbow, a non-tubular elbow attached to a second end of said subassembly, and a non-tubular attachment arm attached to a distal end of said non-tubular elbow and extending outwardly therefrom wherein the holding member is formed to include an upwardly-facing aperture, and wherein a subassembly comprising said base portion and said holding member comprise an axial centerline;
attaching said attachment arm to a vertical surface;
providing a funnel comprising a truncated conical portion and a stem portion extending outwardly from a narrow end of said truncated cone, wherein said stem portion comprises a stem diameter, wherein said funnel was used to channel a fluid comprising a viscosity, and wherein residual fluid remains disposed in said truncated cone portion and in said stem portion;
removeably disposing said stem portion of said funnel in said upwardly-facing aperture; and
draining said residual fluid from said funnel through said tubular base portion, through said tubular elbow, and into said catch.

14. The method of claim 13, wherein said attaching comprises pivotally attaching.

15. The method of claim 13, wherein:
said axial centerline and said vertical surface define a dihedral angle; and
said dihedral angle can be adjusted from about zero degrees to about 40 degrees.

16. The method of claim 15, further comprising adjusting said dihedral angle based upon said viscosity.

17. The method of claim 16, wherein:
if said fluid comprises a viscosity of between 0 and 10 centipoises, then adjusting said dihedral angle to be between about 0 to about 10 degrees;
if said fluid comprises a viscosity of between 10 and 100 centipoises, then adjusting said dihedral angle to be between about 10 to 20 degrees;
if said fluid comprises a viscosity of between 100 and 1,000 centipoises, then adjusting said dihedral angle to be between about 20 to about 30 degrees; and
if said fluid comprises a viscosity of between 1,000 and 10,000 centipoises, then adjusting said dihedral angle to be between about 30 to about 40 degrees.

18. The method of claim 15, wherein the catch is sealable when not affixed.

19. The method of claim 15, wherein the catch is disposable.

20. The method of claim 15 wherein the catch further comprises a filter.
